(19) United States
(12) Patent Application Publication
(10) Pub. No.: US 2021/0086445 A1
(43) Pub. Date: Mar. 25, 2021

(54) SHAPING DEVICE AND SHAPING METHOD

(71) Applicant: MIMAKI ENGINEERING CO., LTD., Nagano (JP)

(72) Inventor: Kenji Harayama, Nagano (JP)

(21) Appl. No.: 17/009,195

(22) Filed: Sep. 1, 2020

(30) Foreign Application Priority Data
Sep. 19, 2019 (JP) 2019-170337

(51) Int. Cl. B29C 64/209; B33Y 30/00; B33Y 40/00; B29C 64/393; B33Y 50/02; B29C 64/112; B33Y 10/00; B29C 67/00

(52) U.S. Cl. CPC B29C 64/209; B33Y 30/00; B33Y 40/00; B29C 64/393; B29K 2995/0021; B29C 64/112; B33Y 10/00; B29C 67/0007; B33Y 50/02

(57) ABSTRACT

A shaping device for shaping a three-dimensional shaped object, the shaping device including a plurality of inkjet heads, which are a plurality of ejection heads, and a control unit; where at least some of the plurality of inkjet heads ejects ink to become the material for coloring; and the control unit causes the plurality of inkjet heads to eject ink so that the shaped object in which a way of coloring for at least one part is different from a way of coloring for at least other parts is shaped based on shaping data, which is data indicating shape and color of the shaped object, and coloring system designating data, which is data indicating the way of coloring for at least one part of the shaped object.

### CROSS REFERENCE TO RELATED APPLICATIONS

This application claims the priority benefit of Japanese Patent Application No. 2019-170337, filed on Sep. 19, 2019. The entirety of the above-mentioned patent application is hereby incorporated by reference herein and made a part of this specification.

### TECHNICAL FIELD

The present disclosure relates to a shaping device and a shaping method.

### DESCRIPTION OF THE BACKGROUND ART

Conventionally, a shaping device (3D printer) for shaping a shaped object using an inkjet head is known (see e.g., Japanese Unexamined Patent Publication No. 2015-071282). In such a shaping device, for example, the shaped object is shaped through a layered shaping method by overlapping a plurality of ink layers formed by an inkjet head. Furthermore, conventionally, a shaping device or the like that shapes a shaped object colored in various colors by using materials of a plurality of colors as a shaping material is known.

### SUMMARY

In recent years, due to the widespread use of the shaping device and the like, it is desired to perform more diverse coloring when shaping a colored shaped object. The present disclosure thus provides a shaping device and a shaping method capable of overcoming such problem.

The inventor of the present application has conducted thorough research on a method of performing diverse colorings when shaping a colored shaped object. The inventor then contrived of differing the way of coloring depending on the position of the shaped object. According to this configuration, for example, more diverse coloring can be performed on the shaped object. Furthermore, the inventor of the present application considered using data (coloring system designating data) indicating the way of coloring a shaped object as a method of differing the way of coloring depending on the position of the shaped object. According to this configuration, for example, a part of the shaped object can be appropriately colored through a method different from other positions.

Through further thorough researches, the inventor of the present application found features necessary for obtaining such effects and contrived the present disclosure. In order to solve the problems described above, the present disclosure provides a shaping device for shaping a three-dimensional shaped object, the shaping device including a plurality of ejection heads each ejecting a material of the shaped object; and a control unit that controls the operation of the plurality of ejection heads; where at least some of the plurality of ejection heads ejects the material for coloring; and the control unit causes the plurality of ejection heads to eject the material so that the shaped object in which a way of coloring for at least one part is different from a way of coloring for at least other parts is shaped based on shaping data, which is data indicating shape and color of the shaped object, and coloring system designating data, which is data indicating the way of coloring for at least one part of the shaped object.

With this configuration, for example, a way of coloring a part of the shaped object is different from that of the other parts, so that the colored shaped object can be appropriately shaped. This also allows, for example, the variously colored shaped object to be appropriately shaped.

In this configuration, as the coloring system designating data, for example, data indicating the shape and color of at least a part of the shaped object can be suitably used in the same format as the shaping data. In this case, the color indicated by the coloring system designating data can, for example, be considered not as the color of the shaped object itself but as the color indicating the way of coloring. With this configuration, for example, the software that handles the shaping data can appropriately handle the coloring system designating data in the same manner as the shaping data. Furthermore, in this case, it is conceivable to use, as at least a part of the colors used in the coloring designating data, a color associated with the way of coloring applied to the shaped object. With this configuration, for example, the way of coloring can be designated by specifying a color in the coloring system designating data. Furthermore, for example, the way of coloring can be appropriately designated in the coloring system designating data in the same format as the shaping data.

Further, in this case, a plurality of colors respectively associated with different ways of coloring may be used in the coloring system designating data. With this configuration, for example, various ways of coloring can be appropriately designated in the coloring system designating data. As the coloring system designating data, for example, it is conceivable to indicate the entire shape of the shaped object indicated by the shaping data. With this configuration, for example, the way of coloring can be appropriately designated for each part of the shaped object.

In this configuration, the control unit, for example, differs the way of coloring for one part of the shaped object and at least other parts so that the way of shaping with respect to the region where the same color is designated in the shaping data becomes different. With such a configuration, for example, a variously colored shaped object can be appropriately shaped. Making the way of coloring different can also be considered as, for example, differing the way of ejecting the shaping material from a plurality of ejection heads when drawing the same image.

Furthermore, in this configuration, the shaping device includes, for example, as a plurality of ejection heads, a plurality of coloring heads, which are a plurality of ejection heads each ejecting a material for coloring, and a light reflective material head which is an ejection head that ejects a light reflective material. Then, as the shaped object, for example, a shaped object including a light reflecting region which is a light reflecting region formed using a light reflective material, and a region to be colored which is a colored region formed using the material for coloring. Moreover, in this case, the control unit, based on the coloring system designating data, causes the plurality of coloring heads and the light reflective material head to form, as at least a part of the region to be colored, a reflective color portion, which is a region that is colored to reflect light entering from the outside by being formed using the light reflective material and the material for coloring, and a transmissive color portion, which is a region that is colored to transmit light entering from the outside by using the material for coloring and is formed in at least a part of a periphery of the light reflecting region. Further, in this case, as the coloring system designating data, for example, data indicating a position to form at least one of the reflective color portion and the transmissive color portion is used.

With such a configuration, for example, the way of coloring a part of the shaped object can be appropriately made different from the other parts. Furthermore, in this case, the reflective color portion can be considered as, for example, a part colored through the bulk color system (bulk coloring system) which is a method of coloring the region without using other light reflecting regions. Moreover, the transmissive color portion can be considered as, for example, a part colored through the surface color system (surface coloring system), which is a method of coloring the surface overlapping with the light reflecting region. Furthermore, in this case, the coloring system designating data can be considered as, for example, data that designates a position for performing the coloring through the bulk color system and a position for performing the coloring through the surface color system.

As the way of coloring designated by the coloring system designating data, it is considered to designate other further ways of coloring. More specifically, for example, when forming a region to be colored in at least a part of the periphery of the light reflecting region, it is conceivable to differ the way of coloring by differing the thickness of the region to be colored depending on the position. In this case, the control unit, based on the coloring system designating data, causes the plurality of ejection head to form, as at least a part of the region to be colored, for example, a first thickness color portion formed so that a thickness in a normal direction becomes a first thickness, and a second thickness color portion formed so that a thickness in the normal direction becomes a second thickness different from the first thickness. In this case, the normal direction can be considered as, for example, the normal direction at each position on the surface of the shaped object. Further, in this case, it is conceivable to use, as the coloring system designating data, data indicating a position to form at least one of the first thickness color portion and the second thickness color portion. Even with such a configuration, for example, a way of coloring a part of the shaped object can be appropriately made different from other parts.

Further, in this configuration, the control unit, based on a result of a color conversion process performed according to a profile that associates a color space corresponding to a color used in the shaping data with a color space corresponding to a color of the material for coloring, causes the plurality of ejection heads to form the shaped object including a region to be colored. In this case, as the coloring system designating data, it is conceivable to use data that designates a profile to be used. More specifically, in this case, the control unit, based on the coloring system designating data, causes the plurality of ejection heads to form, as at least a part of the region to be colored, for example, a first profile corresponding part in which color conversion process is performed using a first profile and a second profile corresponding part in which color conversion process is performed using a second profile different from the first profile. Furthermore, in this case, as the coloring system designating data, for example, it is conceivable to use data indicating a position to form at least one of the first profile corresponding part and the second profile corresponding part. Even with such a configuration, for example, a way of coloring a part of the shaped object can be appropriately made different from other parts.

Moreover, as a way of coloring the shaped object, for example, it is conceivable to perform coloring by overlapping a plurality of layered parts having different colors. Then, in this case, as the coloring system designating data, it is conceivable to use data that designates a part to perform coloring through such a method. More specifically, in this case, the control unit, based on the coloring system designating data, causes the plurality of ejection heads to form as at least a part of the region to be colored, a layer system color representing part. In this case, the layer system color representing part is, for example, a region where a plurality of layered parts having a normal direction in the surface of the shaped object as a thickness direction is overlapped, in which color is represented by overlapping the layered parts having different colors. Furthermore, in this case, as the coloring system designating data, for example, data indicating a position to form the layer system color representing part is used. Even with such a configuration, for example, a way of coloring a part of the shaped object can be appropriately made different from other parts.

Furthermore, the shaped object to be shaped in this configuration can be considered to be, for example, a shaped object including other-system color portion which is a part colored by a predetermined method different from other parts. In this case, as the coloring system designating data, it is conceivable to use, for example, data indicating the position to form the other-system color portion. Even with such a configuration, for example, a way of coloring a part of the shaped object can be appropriately made different from other parts.

In this case, for example, it is also conceivable to form a shaped object including a plurality of other-system color portions that are colored by different methods. Then, in this case, as the coloring system designating data, for example, it is conceivable to use data indicating the positions to form the respective other-system color portions. With such a configuration, for example, a variously colored shaped object can be more appropriately shaped.

Furthermore, more specifically, as such a shaped object, for example, a shaped object representing a human being can be considered. Then, in this case, for example, as other-system color portion, it is conceivable to use a part corresponding to the eyes or the skin of the human being. With this configuration, for example, with respect to a part corresponding to the eyes or the skin, color representation can be appropriately performed with the texture matched to the eyes or the skin. Thus, for example, shaping with higher quality can be more appropriately carried out. Furthermore, in this case, it can be considered that a part corresponding to the eyes or the skin be formed as a layer system color representing part. With this configuration, for example, the texture of eyes, skin, and the like can be appropriately represented with higher accuracy.

Use of a shaping method having the features similar to the above, and the like can be considered for the configuration of the present disclosure. In this case as well, for example, effects similar to the above can be obtained. Furthermore, in this case, the shaping method can be considered as, for example, a manufacturing method for a shaped object.

According to the present disclosure, for example, variously colored shaped object can be appropriately shaped.

### BRIEF DESCRIPTION OF THE DRAWINGS

FIG. 1 is a diagram illustrating a shaping system 10 including a shaping device 12 according to one embodiment of the present disclosure. FIG. 1A illustrates an example of a configuration of the shaping system 10. FIG. 1B illustrates an example of a configuration of a main part of the shaping device 12. FIG. 1C illustrates an example of a configuration of a head unit 102.

FIG. 2 is a diagram describing a shaped object 50 to be shaped in the shaping device 12 of the present example. FIG. 2A illustrates an example of two shaped objects 50 used as parts. FIG. 2B illustrates an object 40 created by combining two shaped objects 50.

FIG. 3 is a diagram describing the respective regions forming the shaped object 50. FIG. 3A illustrates an example of the positional relationship of the respective regions forming the shaped object 50. FIG. 3B illustrates another example of the positional relationship of the respective regions forming the shaped object 50. FIG. 3C illustrates various examples of the way of forming the boundary part between a surface region 502 and an end region 504.

FIG. 4 is a diagram describing the way of coloring the surface region 502 and the end region 504. FIG. 4A illustrates an example in the way of coloring the surface region 502. FIG. 4B illustrates an example in the way of coloring the end region 504.

FIG. 5 is a diagram illustrating an example of an operation of creating an object 40. FIG. 5A illustrates an example of the operation until immediately before the shaping of the shaped object 50 is started in the shaping device 12. FIG. 5B illustrates an example of an operation of performing shaping of the shaped object 50 in the shaping device 12. FIG. 5C illustrates an example of the operation after the shaping of the shaped object 50 by the shaping device 12 is completed.

FIG. 6 is a diagram describing shaping data and coloring system designating data in more detail.

FIG. 7 is a diagram describing the process of generating each region of the shaped object 50 in more detail.

FIG. 8 is a diagram describing a modified example of a way of coloring the shaped object 50. FIG. 8A illustrates an example of a region to be colored formed in a modified example in the way of coloring the shaped object 50 together with an inner region 506. FIG. 8B illustrates an example of a region to be colored formed in a further modified example in the way of coloring the shaped object 50.

FIG. 9 is a diagram describing a further modified example in the way of coloring the shaped object 50. FIGS. 9A and 9B illustrate an example of the shaping data and the coloring system designating data used in this modified example.

FIG. 10 is a diagram describing a further modified example in the way of coloring the shaped object 50.

### DETAILED DESCRIPTION OF EMBODIMENTS

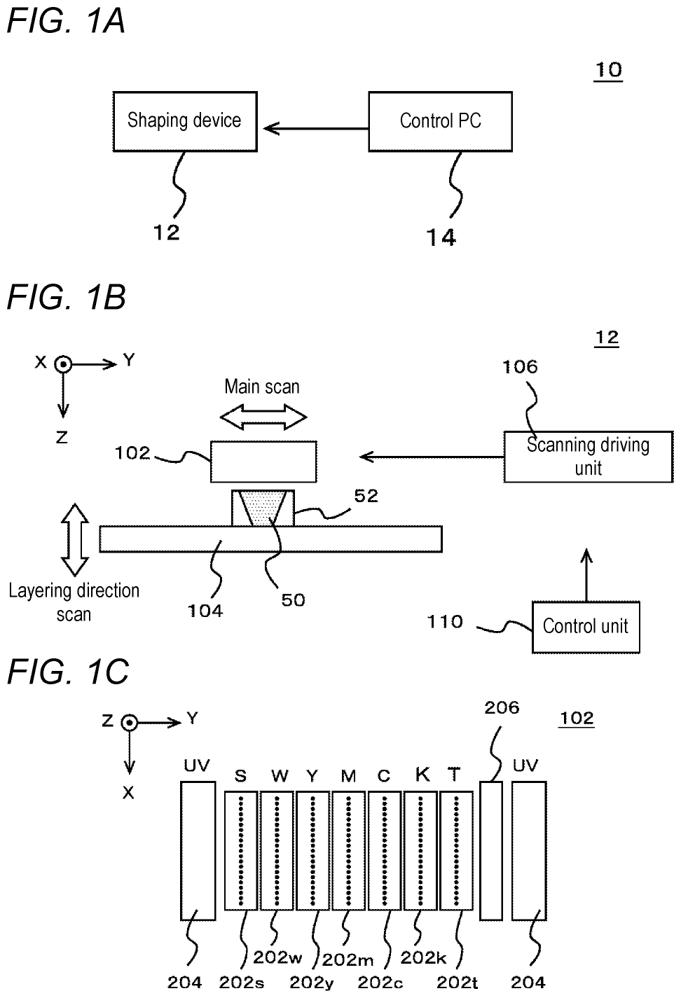

Hereinafter, an embodiment according to the present disclosure will be described with reference to the drawings. FIG. 1 is a diagram illustrating a shaping system 10 including a shaping device 12 according to one embodiment of the present disclosure. FIG. 1A illustrates an example of a configuration of the shaping system 10. In the present example, the shaping system 10 is a system that shapes a three-dimensional shaped object 50, and includes a shaping device 12 and a control PC 14.

The shaping device 12 is a device (3D printer) for shaping a three-dimensional shaped object through the layered shaping method, and shapes the shaped object according to the control of the control PC 14. In this case, the layered shaping method can be considered as, for example, a method of overlapping a plurality of layers to shape a shaped object. Furthermore, the shaped object can be considered as, for example, a stereoscopic three-dimensional structural object shaped by the shaping device 12. Moreover, in the present example, the shaping device 12 is a full-color shaping device capable of shaping a shaped object colored in full color, and receives input data indicating a shaped object to be shaped from the control PC 14 and shapes the shaped object based on such input data. More specifically, the shaping device 12 generates slice data indicating a cross-section of the shaped object based on the input data, and ejects ink according to the slice data to form respective ink layers that form the shaped object.

The control PC 14 is a computer (host PC) that controls the operation of the shaping device 12, and controls the shaping operation of the shaping device 12 by providing input data to the shaping device 12. In this case, the control PC 14 provides, for example, input data indicating a shaped object in which at least one part is colored to the shaping device 12.

More specifically, in the present example, the control PC 14 provides the input data indicating a shaped object in which coloring is performed on the surface, where hue can be visually recognized from the outside, to the shaping device 12. Furthermore, the control PC 14 provides the shaping data and the coloring system designating data to the shaping device 12 as the input data. In this case, the shaping data is data indicating the shape and color of the shaped object to be shaped by the shaping device 12. The coloring system designating data is data indicating the way of coloring at least a part of the shaped object. The way of using the shaping data and the coloring system designating data, and the like will be described in more detail later.

As described above, in the present example, the shaping system 10 is configured by the shaping device 12 and the control PC 14, which are a plurality of devices. However, in a modified example of the shaping system 10, the shaping system 10 may be configured by a single device. In this case, for example, it is conceivable to configure the shaping system 10 with a single shaping device 12 also having the function of the control PC 14. The shaping system 10 may further include devices other than the shaping device 12 and the control PC 14.

Furthermore, in the present example, the shaping device 12 has, for example, the configuration illustrated in FIG. 1B. FIG. 1B illustrates an example of a configuration of a main part of the shaping device 12. In the present example, the shaping device 12 includes a head unit 102, a shaping table 104, a scanning driving unit 106, and a control unit 110. Other than the points described above and below, the shaping device 12 may have a configuration same as or similar to a known shaping device. More specifically, other than the points described below, the shaping device 12 may have a feature same as or similar to a known shaping device that carries out shaping by ejecting a droplet to become the material of the shaped object 50 using an inkjet head. Furthermore, other than the illustrated configuration, the shaping device 12 may further include, for example, various types of configurations necessary for the shaping, and the like of the shaped object 50.

The head unit 102 is a part that ejects the material of the shaped object 50. Furthermore, in the present example, ink is used as the material of the shaped object 50. In this case, for example, the ink can be considered as a functional liquid or the like. Moreover, in the present example, for example, liquid, and the like ejected from the inkjet head can also be considered as the ink. More specifically, the head unit 102 ejects ink that cures according to predetermined conditions from a plurality of inkjet heads as a material of the shaped object 50. Then, the respective layers forming the shaped object 50 are overlapped and formed by curing the ink after landing to shape the shaped object 50 by the layered shaping method. Moreover, in the present example, an ultraviolet-curable ink (UV ink) that cures from a liquid state by irradiation of ultraviolet light is used as the ink. Furthermore, the head unit 102 further ejects a material of a support layer 52 in addition to the material of the shaped object 50. The head unit 102 thereby forms the support layer 52 at a periphery of the shaped object 50, and the like as necessary. The support layer 52 is, for example, a layered structural object that supports at least a part of the shaped object 50 being shaped. The support layer 52 is formed as necessary at the time of shaping the shaped object 50 and removed after the shaping is completed.

The shaping table 104 is a table-shaped member that supports the shaped object 50 being shaped, and is disposed at a position facing the inkjet head in the head unit 102, and mounts the shaped object 50 being shaped on the upper surface thereof. Furthermore, in the present example, the shaping table 104 has a configuration in which at least the upper surface is movable in a layering direction (Z direction in the drawing), and moves at least the upper surface in accordance with the progress of the shaping of the shaped object 50 by being driven by the scanning driving unit 106. In this case, the layering direction means, for example, a direction in which the material of the shaped object is layered in the layered shaping method. More specifically, in the present example, the layering direction is a direction orthogonal to a main scanning direction (Y direction in the drawing) and a sub scanning direction (X direction in the drawing) set in advance in the shaping device 12.

The scanning driving unit 106 is a driving unit that causes the head unit 102 to perform a scanning operation of relatively moving with respect to the shaped object 50 being shaped. In this case, “relatively moving with respect to the shaped object 50 being shaped” means, for example, relatively moving with respect to the shaping table 104. To cause the head unit 102 to perform the scanning operation means, for example, to cause the inkjet head of the head unit 102 to perform the scanning operation. Furthermore, in the present example, the scanning driving unit 106 causes the head unit 102 to perform the main scan (Y scanning), the sub scan (X scanning), and the layering direction scan (Z scanning).

The main scan is, for example, an operation of ejecting ink while relatively moving in the main scanning direction with respect to the shaped object 50 being shaped. In this example, the scanning driving unit 106 causes the head unit 102 to perform the main scan by fixing the position of the shaping table 104 in the main scanning direction and moving the head unit 102 side. Furthermore, for example, the scanning driving unit 106 may move the shaped object 50 side by fixing the position of the head unit 102 in the main scanning direction and moving, for example, the shaping table 104. The sub scan means, for example, an operation of relatively moving with respect to the shaped object 50 being shaped in the sub scanning direction orthogonal to the main scanning direction. Furthermore, in the present example, the sub scan is an operation of relatively moving with respect to the shaping table 104 in the sub scanning direction by a feed amount set in advance. The scanning driving unit 106 causes the head unit 102 to perform the sub scan between the main scans by fixing the position of the head unit 102 in the sub scanning direction and moving the shaping table 104. The scanning driving unit 106 may cause the head unit 102 to perform the sub scan by fixing the position of the shaping table 104 in the sub scanning direction and moving the head unit 102.

The layering direction scan is, for example, an operation of relatively moving the head unit 102 in the layering direction with respect to the shaped object 50 being shaped. The scanning driving unit 106 adjusts the relative position of the inkjet head with respect to the shaped object 50 being shaped in the layering direction by causing the head unit 102 to perform the layering direction scan in accordance with the progress of the shaping operation. Furthermore, in the layering direction scan of the present example, the scanning driving unit 106 fixes the position of the head unit 102 in the layering direction and moves the shaping table 104. The scanning driving unit 106 may fix the position of the shaping table 104 in the layering direction and move the head unit 102.

The control unit 110 has a configuration including, for example, a CPU of the shaping device 12, and controls the shaping operation of the shaped object 50 by controlling each unit of the shaping device 12. Furthermore, in the present example, the control unit 110 generates slice data based on the input data received from the control PC 14. In this case, the slice data can be considered as, for example, data indicating the cross-section of the shaped object 50 at each position in the layering direction. Furthermore, in the present example, the control unit 110 generates a plurality of pieces of slice data corresponding to a plurality of ink layers that form the shaped object 50. Then, in the operation of forming respective ink layers that form the shaped object 50, the control unit 110 controls the operation of each inkjet head in the head unit 102, for example, to cause each inkjet head to eject the ink to use for the shaping of the shaped object 50.

Furthermore, the head unit 102 in the shaping device 12 has, for example, a configuration illustrated in FIG. 1C. FIG. 1C illustrates an example of a configuration of the head unit 102. In the present example, the head unit 102 includes a plurality of inkjet heads, a plurality of ultraviolet light sources 204, and a flattening roller 206. As illustrated in the drawing, the plurality of inkjet heads include an inkjet head 202s, an inkjet head 202w, an inkjet head 202y, an inkjet head 202m, an inkjet head 202c, an inkjet head 202k, and an inkjet head 202t. The plurality of inkjet heads are, for example, one example of an ejection head that ejects the shaping material, and are disposed side by side in the main scanning direction with their positions in the sub scanning direction aligned. Furthermore, each inkjet head includes a nozzle row, in which a plurality of nozzles are lined in a predetermined nozzle row direction, on a surface facing the shaping table 104. Moreover, in the present example, the nozzle row direction is a direction parallel to the sub scanning direction.

Among these inkjet heads, the inkjet head 202s is an inkjet head that ejects the material of the support layer 52. For example, a known material for the support layer can be suitably used for the material of the support layer 52. The inkjet head 202w is an inkjet head that ejects ink of white color (W color). In this case, the inkjet head 202w is an example of a light reflective material head. White ink is an example of a light reflective material.

The inkjet head 202y, the inkjet head 202m, the inkjet head 202c, and the inkjet head 202k (hereinafter referred to as the inkjet heads 202y to 202k) are inkjet heads for coloring used at the time of shaping the colored shaped object 50. More specifically, the inkjet head 202y ejects ink of yellow color (Y color). The inkjet head 202m ejects ink of magenta color (M color). The inkjet head 202c ejects ink of cyan color (C color). Furthermore, the inkjet head 202k ejects ink of black color (K color). In addition, in the present example, each color of YMCK is an example of a process color used for full color representation by subtractive color mixing method. Moreover, these inks of each color are one example of a material for coloring. The material for coloring can be considered as, for example, a material or the like used to color a region to be colored in the shaped object 50. Furthermore, each of the inkjet heads 202y to 202k is an example of a coloring head that ejects materials for coloring of colors different from each other.

The inkjet head 202t is an inkjet head that ejects a clear ink. The clear ink is, for example, an ink of colorless and transparent (T) clear color. Furthermore, clear ink is an example of a clear color material which is an uncolored translucent material. Moreover, in the present example, the inkjet head 202t is also an example of a clear material head.

The plurality of ultraviolet light sources 204 are light sources (UV light sources) for curing ink, and generate an ultraviolet light that cures the ultraviolet-curable ink. Moreover, in the present example, each of the plurality of ultraviolet light sources 204 is disposed on one end side and the other end side in the main scanning direction in the head unit 102 so as to sandwich the plurality of inkjet heads in between. For example, UVLED (ultraviolet LED) and the like can be suitably used for the ultraviolet light source 204. Furthermore, it is also conceivable to use a metal halide lamp, a mercury lamp, and the like for the ultraviolet light source 204. The flattening roller 206 is a flattening unit for flattening the ink layer formed during the shaping of the shaped object 50. The flattening roller 206, for example, flattens the layer of ink by making contact with a surface of the ink layer and removing a part of the ink before being cured at the time of the main scan.

The ink layer forming the shaped object 50 can be appropriately formed by using the head unit 102 having the configuration described above. Furthermore, the shaped object 50 can be appropriately shaped by overlapping and forming a plurality of ink layers. Moreover, the specific configuration of the head unit 102 is not limited to the configuration described above, and can be variously modified. For example, the head unit 102 may further include an inkjet head for a color other than the above as an inkjet head for coloring. Furthermore, the arrangement of a plurality of inkjet heads in the head unit 102 can be variously modified. For example, the positions in the sub scanning direction of some inkjet heads may be shifted from the other inkjet heads.

Next, a configuration of the shaped object 50 shaped by the shaping device 12 of the present example will be described in more detail. As described above, in the present example, the shaping device 12 receives the shaping data and the coloring system designating data as input data from the control PC 14, and shapes the shaped object 50 based on the shaping data and the coloring system designating data. Then, in this case, the control unit 110 of the shaping device 12 causes the plurality of inkjet heads in the head unit 102 to eject ink so that the shaped object 50 is shaped in which the way of coloring for one part is different from the way of coloring for at least other parts, for example, based on the shaping data and the coloring system designating data.

In addition, more specifically, in the present example, the shaping device 12 shapes the shaped object 50 used as a part when, for example, combining a plurality of shaped objects 50 to create a cube-shaped object. In this case, among the respective parts of the shaped object 50, the way of coloring is made different between the part that forms the surface of the object in the assembled state of the object and the other parts. In this case, the control unit 110, for example, differs the way of coloring for one part of the shaped object 50 and at least other parts so that the way of shaping with respect to the region where the same color is designated in the shaping data becomes different. Making the way of coloring different so that the way of shaping with respect to the region where the same color is designated in the shaping data becomes different can be considered as, for example, making the configuration of the ink layer used to represent the same color different between one part of the shaped object and other parts.

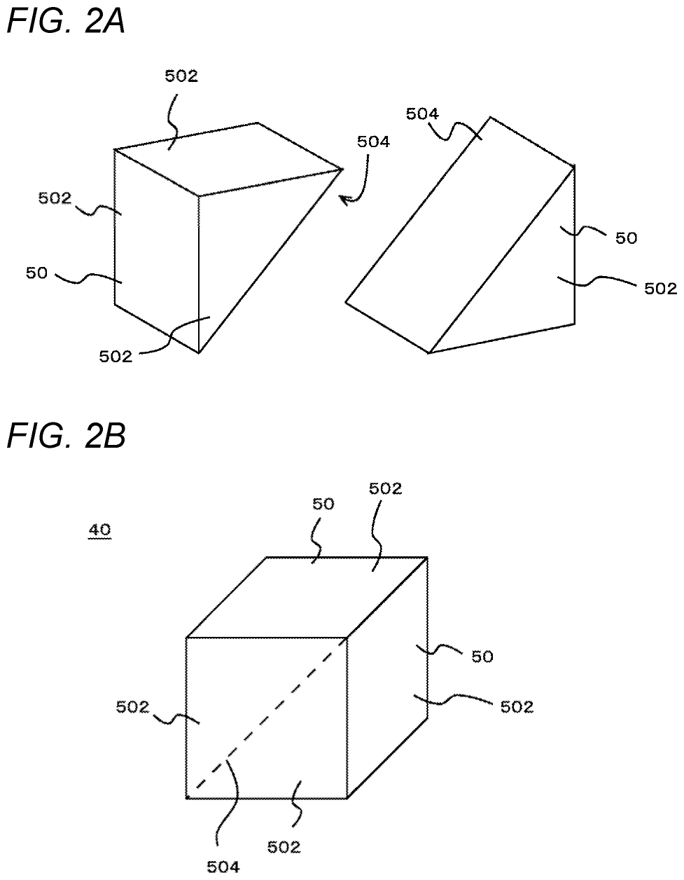

FIG. 2 is a diagram describing the shaped object 50 to be shaped in the shaping device 12 of the present example, and illustrates one example of a configuration of the shaped object 50 used as parts in a case where a cube-shaped object 40 is created by combining two shaped objects 50. FIG. 2A illustrates one example of the two shaped objects 50 used as parts. FIG. 2B illustrates the object 40 created by combining two shaped objects 50.

As can be understood from the matters illustrated in FIGS. 2A and 2B, when creating the object 40 by combining a plurality of shaped objects 50 used as parts, only a part of the shaped object 50 is exposed on the surface of the object 40 in a state after the object 40 is assembled. In this case, the surface of the shaped object 50 can be considered to have, for example, a surface region 502 and an end region 504. In this case, the surface region 502 can be considered as, for example, a part that forms a part of the surface of the object 40 in a state where the object 40 is assembled. The end region 504 can be considered as, for example, a region that becomes an end on the side of other parts (shaped object 50) inside the object 40 in a state where the object 40 is assembled.

Furthermore, in a state where the object 40 is assembled, the surface of the object 40 is configured by the surface region 502 of the shaped object 50, as illustrated in FIG. 2B. Moreover, depending on the shapes of the object 40 and the shaped object 50, the surface of the shaped object 50 may further include a region other than the surface region 502 and the end region 504. In addition, in the shaped object 50 of the present example, an inner region formed by using white ink is further formed at least on the inner side of the surface region 502. In this case, the inner region can be considered as an example of a light reflecting region formed using a light reflective material. Furthermore, the shaped object 50 of the present example can be considered to include, for example, the surface region 502, the end region 504, and the inner region.

Furthermore, in consideration of creating the object 40 whose surface is colored, it seems that, in principle, only the surface region 502 of the surface of the shaped object 50 should be colored. However, at the time of creating the object 40 (at the time of combining the shaped objects 50), for example, a part of the end region 504 of the shaped object 50 is sometimes visually recognized from the outside of the object 40 when misalignment occurs at the joining surface of the shaped object 50. Furthermore, in this case, the color of the end region 504 may affect the appearance of the object 40. More specifically, for example, when the end region 504 is not colored and is formed as a white region like the inner region 506, the color of the end region 504 may be visually recognized from the outside of the object 40, and the joining surface may stand out. On the other hand, in the present example, the end region 504 is also colored to reduce the influence of the conspicuous divided surface even when misalignment occurs at the joining surface. In this case, it is conceivable to color the end region 504 with the same or similar color as the surface region 502. Furthermore, in this case, in the shaped object 50 of the present example, it can be considered that the part where the surface region 502 and the end region 504 are combined is the region to be colored.

Furthermore, when coloring is performed on the end region 504, if the coloring is simply performed on end region 504 in the same manner as the surface region 502, for example, the color of the end region 504 may appear as a dark color. More specifically, as described above, the end region 504 is a region to become the end on the side of the other shaped object 50 inside the object 40. In this case, since the orientation of the object 40 with respect to the surface is different between the surface of the surface region 502 and the surface of the end region 504, there may be a difference in the way the color is seen between the surface region 502 and the end region 504. Furthermore, in this case, in the end region 504 in an orientation whose surface intersects with the surface of the object 40, for example, the path through which light passes becomes long, and thus the color is likely to be visually recognized as dark. Therefore, even if coloring is performed on the end region 504, if the coloring is simply performed in the same manner as the surface region 502, the joining surface may be conspicuous when misalignment occurs at the joining surface, and the like.

On the other hand, in the present example, the way of coloring the end region 504 is made different from the way of coloring the surface region 502, as will be described in detail later, by further using the coloring system designating data in addition to the shaping data. Thus, for example, the joining surface is more appropriately prevented from standing out when misalignment occurs at the joining surface, and the like.

Subsequently, a way of coloring the surface region 502 and the end region 504 will be described in more detail. Furthermore, in relation to the way of coloring the surface region 502 and the end region 504, first, the position of each region forming the shaped object 50 will be described in more detail.

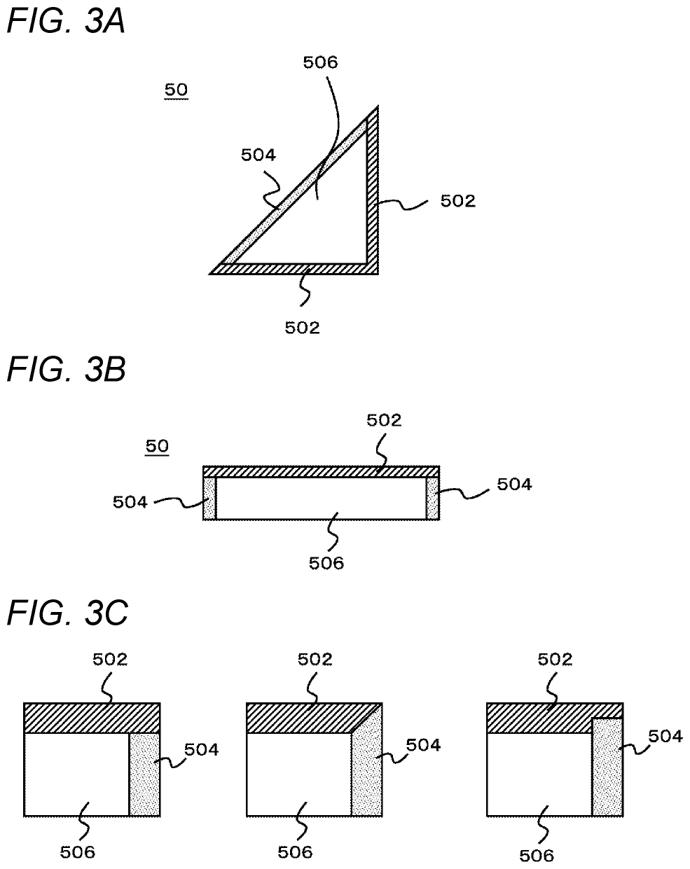

FIG. 3 is a diagram describing each region forming the shaped object 50. FIG. 3A is a view illustrating an example of the positional relationship of the respective regions forming the shaped object 50, and illustrates an example of a configuration of a cross-section of the shaped object 50 for one of the shaped objects 50 illustrated in FIG. 2. Furthermore, for the sake of convenience of illustration, in FIG. 3, different hatching patterns are illustrated for different ways of coloring.

As described above, in the present example, the shaped object 50 includes the surface region 502, the end region 504, and the inner region 506. Then, in this case, the surface region 502 is formed with a constant thickness, for example, at a position on the surface of the shaped object 50 that configures the surface (outer surface) of the object 40 (see FIG. 2). Furthermore, the end region 504 is formed with a constant thickness, for example, at a position on the surface of the shaped object 50 other than the range where the surface region 502 is formed. Forming the surface region 502 and the end region 504 with a constant thickness means that the surface region 502 and the end region 504 are formed with a substantially constant thickness according to the resolution of shaping and the like. Moreover, forming with a constant thickness can be considered as, for example, forming the region such that the difference from the reference thickness falls within a certain allowable range. In this case, a part other than the surface region 502 and the end region 504 in the shaped object 50 becomes the inner region 506. Furthermore, in the case illustrated in FIG. 3A, the inner region 506 can also be considered as, for example, a region other than the surface of the shaped object 50.

Furthermore, the positional relationship of the respective regions forming the shaped object 50 may be different from the above depending on the configuration of the object 40. FIG. 3B is a diagram illustrating another example of the positional relationship of the respective regions forming the shaped object 50, and illustrates an example of a configuration of a cross-section of the shaped object 50 for the shaped object 50 having a shape different from the shaped object 50 illustrated in FIG. 2. When the shaped object 50 is used as a part of the object 40, a part of the surface of the shaped object 50 may become a part that is not visible from the outside of the object 40 depending on the shape of the object 40 or the shaped object 50. In such a case, a part of the surface of the shaped object 50 may be formed without coloring.

In this case as well, it is conceivable to form the surface region 502 with a constant thickness, for example, at a position on the surface of the shaped object 50 that configures the surface (outer surface) of the object 40. Furthermore, it is also conceivable to form the end region 504 with a constant thickness, for example, at a position of a part of the surface of the shaped object 50 other than the range where the surface region 502 is formed. Moreover, it is conceivable to form the inner region 506, for example, at a position other than the surface region 502 and the end region 504, while including a part of the surface of the shaped object 50. In consideration of such a configuration, the inner region 506 can be considered to be, for example, a region that forms a part of the inside of the object 40 in a state where the object 40 is assembled.

Furthermore, FIGS. 3A and 3B illustrate a configuration for a case where priority is given to forming the surface region 502 with a constant thickness for the boundary part between the surface region 502 and the end region 504. However, various configurations can be used for the way of forming the boundary part between the surface region 502 and the end region 504.

FIG. 3C illustrates various examples of the way of forming the boundary part between the surface region 502 and the end region 504. In FIG. 3C, the leftmost view illustrates an example of a case where a boundary part is formed similar to the case illustrated in FIGS. 3A and 3B. In this case, the surface region 502 is formed with a constant thickness at the position forming the surface (outer surface) of the object 40, while including the boundary part with the end region 504. With this configuration, for example, the surface region 502 can be formed on the entire surface of the object 40 under the same conditions.

In addition, in FIG. 3C, the central view illustrates an example of a case where the boundary part between the surface region 502 and the end region 504 is formed so as to be divided into the surface region 502 and the end region 504. More specifically, in this case, a part of the surface region 502 connecting to the end region 504 is formed such that the thickness gradually reduces (thins) toward the end. Furthermore, in this case, it can be considered that the thickness gradually reduces toward the end also for a part of the end region 504 connecting to the surface region 502. With this configuration, for example, the boundary between the surface region 502 and the end region 504 can be made inconspicuous, and the surface region 502 and the end region 504 can be connected more naturally.

Furthermore, as will be described in more detail later, in the present example, the end region 504 is colored so that the region itself has light reflectivity. In this case, it can be considered that the end region 504 formed on the inner side (back side) of the surface region 502 at the boundary part between the surface region 502 and the end region 504 becomes a region to be colored that also has a function as a light reflecting region. In this case, the end region 504 can be used as a light reflecting region in the vicinity of the boundary part between the surface region 502 and the end region 504.

Moreover, in this case, the thickness of the surface region 502 is preferably adjusted in consideration of the color colored in the end region 504. Therefore, in the surface region 502, the thickness of the part overlapping the end region 504 may be different from that of the other parts. More specifically, in this case, it is considered to slightly reduce the thickness of the surface region 502, and the like at the boundary part between the surface region 502 and the end region 504. In this case, for example, it is conceivable to form the boundary part as illustrated in the rightmost view in FIG. 3C.

In FIG. 3C, the rightmost view illustrates an example of a case where the boundary part is formed such that the thickness of the surface region 502 becomes smaller than that of the other parts at the boundary part between the surface region 502 and the end region 504. In this case, the end region 504 is formed so as to enter the surface region 502 by an amount corresponding to the reduced thickness of the surface region 502. With this configuration, for example, the thickness of the surface region 502 can be appropriately adjusted in consideration of the color of the end region 504.

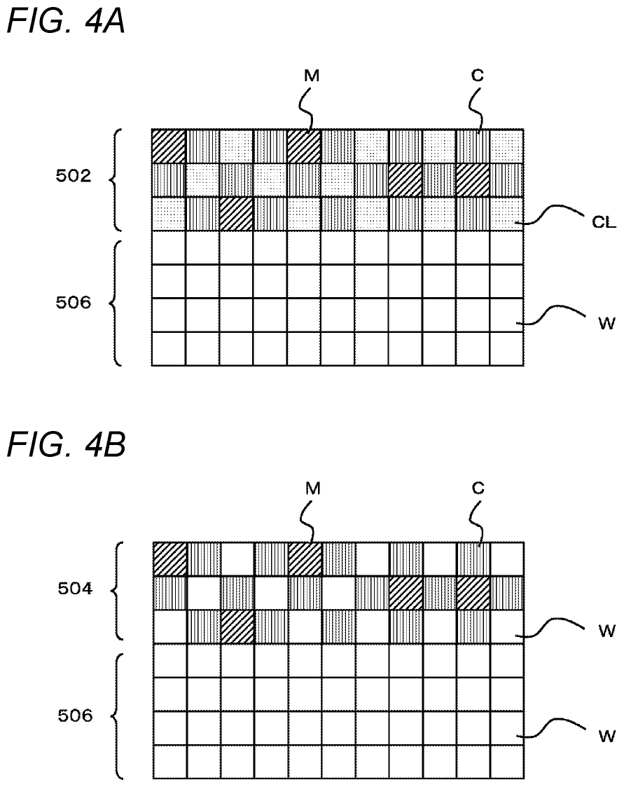

FIG. 4 is a diagram describing a way of coloring the surface region 502 and the end region 504. Furthermore, for the sake of convenience of illustration, in FIG. 4, different hatching patterns are illustrated for difference in colors.

FIG. 4A illustrates an example of a way of coloring the surface region 502. As described above, in the present example, the surface region 502 is formed in a colored state. In this case, coloring the surface region 502 may mean, for example, coloring at least a part of the surface region 502. In the present example, the surface color system (surface coloring system) is used as a way of coloring the surface region 502. In this case, the surface color system can be considered as, for example, a method of coloring the surface overlapping with the inner region 506 which is the light reflecting region.

More specifically, as described above, in the present example, a white region is formed using a white ink as the inner region 506. In this case, the surface region 502 can be considered as, for example, a region where a color is visually recognized as the color of the inner region 506 functions as a background color. Furthermore, in this case, the surface region 502 needs to be formed so that at least a part of the light entering from the outside is reflected by the inner region 506 and emitted to the outside. Therefore, it can be considered that the surface region 502 is formed so that, for example, the light entering from the side opposite to the inner region 506 is reflected by the inner region 506 and emitted to the outside of the shaped object. In this case, the light entering from the side opposite to the inner region 506 being reflected by the inner region 506 and emitted to the outside of the shaped object means that, for example, in a state where a part of the incident light is absorbed in the surface region 502 according to the color to be colored or the like, the component of the light that is not absorbed is emitted. With such a configuration, various colors can be appropriately represented in the surface region 502.

Furthermore, more specifically, in the present example, the surface region 502 is formed by using each color ink of YMCK which is a coloring ink selected according to the color to be colored and the clear ink. Then, in this case, each part of the surface region 502 is formed so that, for example, the total amount of ink per unit volume is constant by differing the ink used among inks of each color of YMCK according to the color to be colored, and changing the usage amount of clear ink in accordance with the change in the usage amount of ink that occurs depending on the difference in color. With this configuration, for example, a difference can be appropriately prevented from forming in the amount of ink depending on the difference in color. Furthermore, for example, the formation of the surface region 502 can be appropriately carried out. Moreover, such a way of using the clear ink can be considered as, for example, a way of compensating for a change in the usage amount of the coloring ink. Furthermore, in this case, such a compensation in the surface region 502 can be considered as a compensation by only clear ink. In addition, it is conceivable that the part of the surface region 502 that is to be formed colorless is formed, for example, only with the clear ink. Furthermore, a part formed only with the clear ink can be considered as, for example, a part that is colored colorless.

Furthermore, in the present example, the end region 504 is colored through a method different from that of the surface region 502, as described above. FIG. 4B illustrates an example of a way of coloring the end region 504. As described above, in the present example, the end region 504 is also formed in a colored state. In this case, coloring the end region 504 may be, for example, coloring at least a part of the end region 504.

In the present example, a bulk color system (bulk coloring system) is used as a way of coloring the end region 504. In this case, the bulk color system can be considered as, for example, a method of coloring the region without using other light reflecting regions. More specifically, in the present example, the end region 504 can be considered as a region where the color is visually recognized as the color of the white ink in the end region 504 functions as a background color by, for example, being formed using white ink in addition to the coloring ink. Furthermore, in FIG. 4B, for the sake of convenience of illustration, the end region 504 is illustrated together with the inner region 506 in accordance with FIG. 4A. However, as can be understood from the above description, the end region 504 can be considered as a region where colors can be visually recognized from the outside without the inner region 506.

Moreover, for example, it can be considered that the end region 504 is formed to have higher light reflectivity than the surface region 502 by using coloring ink and white ink. In this case, the end region 504 having higher light reflectivity than the surface region 502 means that, for example, the content of the white ink per unit volume is greater than that of the surface region 502. The end region 504 having higher light reflectivity than the surface region 502 can be considered as, for example, having higher light reflectivity than the region colored through the surface color system and has sufficient light reflectivity to perform coloring through the bulk color system. Furthermore, in this case, the end region 504 can also be considered as, for example, a region in which color is represented using the light reflected by the end region 504 itself by increasing the light reflectivity. With such a configuration, various colors can be appropriately represented in the end region 504 with a configuration different from the surface region 502.

More specifically, in the present example, the end region 504 is formed by using ink of each color of YMCK, which is a coloring ink selected according to the color to be colored, and a white ink. Then, in this case, each part of the end region 504 is formed so that, for example, the total amount of ink per unit volume is constant by differing the ink used among ink of each color of YMCK according to the color to be colored, and changing the usage amount of white ink in accordance with the change in the usage amount of ink that occurs depending on the difference in color. With this configuration, for example, a difference can be appropriately prevented from forming in the amount of ink depending on the difference in color. Furthermore, for example, the formation of the end region 504 can be appropriately carried out. Moreover, such a way of using the white ink can be considered as, for example, a way of compensating for a change in the usage amount of the coloring ink.

The way of coloring through the bulk color system in the present example can be considered as a method of using white ink instead of the clear ink in the surface color system. Furthermore, in a modified example in the way of coloring through the bulk color system, clear ink may be further used in addition to the coloring ink and the white ink. In this case, it is conceivable to use a white ink instead of the clear ink only at some positions where the clear ink is used in the surface color system. Furthermore, in this case, the operation of changing the usage amount of the white ink in accordance with the change in the usage amount of the ink that occurs depending on the difference in color at each position of the end region 504 can be considered as, for example, the operation of changing the usage amount of the white ink according to one part of the change in the usage amount of the coloring ink. In this case, it is conceivable that the total amount of ink per unit volume becomes constant by changing the total amount of white ink and clear ink according to the change in the usage amount of the coloring ink. Furthermore, in a further modified example in the way of coloring through the bulk color system, consideration is made to perform coloring using a color cell configured by a plurality of ink dots of a predetermined number. In this case, for example, it is conceivable to use a color cell in which the center part is formed of white ink. In addition, it is conceivable that the part to be formed colorless in the end region 504 is formed using, for example, clear ink or white ink. Furthermore, a part formed only with the clear ink or the white ink can be considered as, for example, a part that is colored colorless.

The color of the end region 504 is preferably, for example, a color matched with the surface region 502. In this case, the color matched with the surface region 502 is, for example, the same color as the position in contact with the end region 504 in the surface region 502. Furthermore, in this case, it can be considered that the way of coloring is changed in a state where the color is the same at the boundary part where the surface region 502 and the end region 504 come into contact with each other. In this case, it is conceivable that the part of the end region 504 connecting to the surface region 502 is formed in a colored state in accordance with the color of the edge of the surface region 502. It is also conceivable that the end region 504 is colored with the color strength and the like made different from that of the surface region 502. According to the present example, for example, the surface region 502 and the end region 504 can be appropriately colored through different systems. In addition, this allows, for example, the way the color is seen to be different for the surface region 502 and the end region 504.

Furthermore, in this case, for example, the path in which the light passes can be appropriately prevented from becoming long, and the like, in the end region 504 by coloring the end region 504 through the bulk color system. Therefore, according to the present example, the color of the end region 504 can be appropriately prevented from being visually recognized dark in a state where the object 40 (see FIG. 2) is assembled. In addition, for example, the joining surface of the shaped object 50 can be appropriately prevented from becoming conspicuous in the object 40.

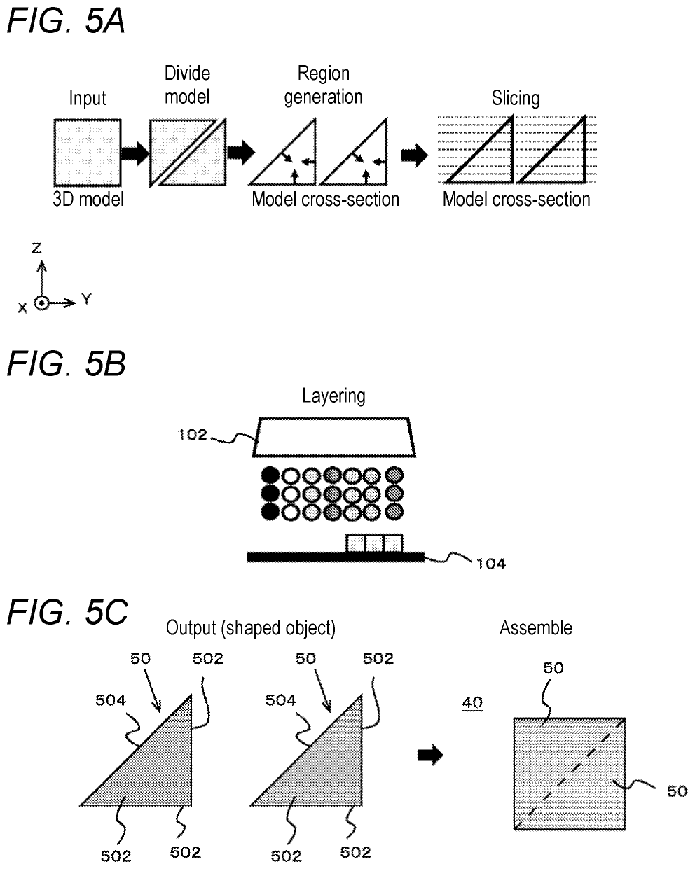

Next, the operation of creating the object 40 in the present example will be described in more detail. FIG. 5 is a view illustrating an example of an operation of creating the object 40. FIG. 5A illustrates an example of the operation until immediately before the shaping of the shaped object 50 is started in the shaping device 12 (see FIG. 1). In this case, starting the shaping of the shaped object 50 in the shaping device 12 means starting the formation of an ink layer that forms the shaped object 50. FIG. 5B illustrates an example of an operation of performing shaping of the shaped object 50 in the shaping device 12. FIG. 5C illustrates an example of the operation after the shaping of the shaped object 50 by the shaping device 12 is completed.

As described above, in the present example, the object 40 is created by combining a plurality of shaped objects 50 used as parts. Then, in this case, first, data indicating the object 40 is prepared, and this data is divided to create data indicating the respective shaped objects 50. The data indicating the object 40 is data indicating the overall shape and color of the object 40, for example, as illustrated as a 3D model in FIG. 5A. The data indicating the object 40 can be considered, for example, as input data before division. Furthermore, as the data indicating the object 40, three-dimensional data (3D data) in a known format can be suitably used. In this case, the color of the object 40 is, for example, the color of the surface of the object 40. It can be considered that the color of the surface of the object 40 may be set, for example, by pasting a texture indicating a color image on the surface of the shape data indicating the three-dimensional shape of the object 40.

Furthermore, in the present example, as illustrated as an operation of dividing the model in the drawing, data indicating a plurality of shaped objects 50 respectively corresponding to the respective parts forming the object 40 is generated by dividing the data indicating the object 40. In this case, for example, it is conceivable to generate data (input data) indicating the respective shaped objects 50 by dividing the object 40 according to a user's instruction. Moreover, as described above, in the present example, shaping data and coloring system designating data are generated as the data indicating the respective shaped objects 50. Furthermore, in the present example, the control PC 14 (see FIG. 1) in the shaping system 10 generates the shaping data and the coloring system designating data. Then, these generated data are provided to the shaping device 12. Moreover, it can be considered that the operation of dividing the model to generate the plurality of shaped objects 50 is automatically performed by the control PC 14.

The shaping device 12 (see FIG. 1) that received the shaping data and the coloring system designating data generates data indicating the shaped object 50 in a format suitable for the shaping operation based on these data. More specifically, in this case, the control unit 110 (see FIG. 1) in the shaping device 12 generates each region (surface region 502, end region 504, inner region 506) that forms the shaped object 50 based on the shaping data and the coloring system designating data. In this case, the control unit 110 determines, for example, for each position on the surface of the shaped object 50, which of the surface region 502 and the end region 504 the position corresponds based on the coloring system designating data. Furthermore, based on this determination, the surface region 502 and the end region 504 are generated so as be regions having a predetermined thickness. Then, a part other than the surface region 502 and the end region 504 is set as the inner region 506. The control unit 110 further generates slice data indicating the cross-section of the shaped object 50 at the position of each ink layer, in accordance with the thickness of the ink layer to be layered in the shaping device 12 based on the generation results of the regions.

Here, in the operation of generating the slice data, the control unit 110 performs color conversion according to a profile prepared in advance. In this case, the profile can be considered as, for example, data that associates colors among a plurality of color spaces. Furthermore, in the present example, as the profile, a profile that associates the color space corresponding to the color used in the shaping data with the color space corresponding to the color of the coloring ink is used. In this case, associating the color spaces can be considered as, for example, associating each color in each color space. With this configuration, for example, a plurality of inkjet heads in the head unit 102 can be caused to form the shaped object 50 including the region to be colored (surface region 502 and end region 504) based on the result of the color conversion performed according to the profile.

Here, the process of generating the region and generating the slice data (slicing process) performed as described above can be carried out in the same or similar manner as a known operation except for the operation of designating the way of coloring using the coloring system designating data. Furthermore, in this case, in the slicing process, for example, the slice data is generated in accordance with the structure of the shaping device 12 by appropriately performing conversion of resolution according to the resolution of shaping, color separation according to the color of the ink to be used, halftone processing, and the like. Moreover, in a modified example of the operation of creating the object 40, for example, the process of generating the region and the slicing process may be performed by the control PC 14. In a further modified example of the operation of creating the object 40, for example, it is conceivable that the operation of dividing the model to generate a plurality of shaped objects 50 is performed by the shaping device 12.

After the slice data is generated, for example, as illustrated in FIG. 5B, an ink layer is formed in the shaping device 12 by ejecting ink from each inkjet head of the head unit 102 toward the shaping table 104. Furthermore, the shaped object 50 is shaped by forming a plurality of ink layers in an overlapping manner.

Thus, in the shaping device 12, a plurality of shaped objects 50 are shaped, for example, as illustrated in FIG. 5C. In this case, for example, it is conceivable that the plurality of shaped objects 50 are shaped simultaneously on the shaping table 104. With such a configuration, a plurality of shaped objects 50 can be efficiently shaped. Furthermore, when the number of shaped objects 50 is large, for example, the plurality of shaped objects 50 used as parts of the object 40 may be shaped in a plurality of times. After the shaping of the plurality of shaped objects 50 is completed, the plurality of shaped objects 50 are combined to create the object 40. In this case, as described above, as the end region 504 is colored through the bulk color system, the joining surface can be appropriately prevented from standing out at the boundary part of the shaped object 50 illustrated with a broken line in the drawing.

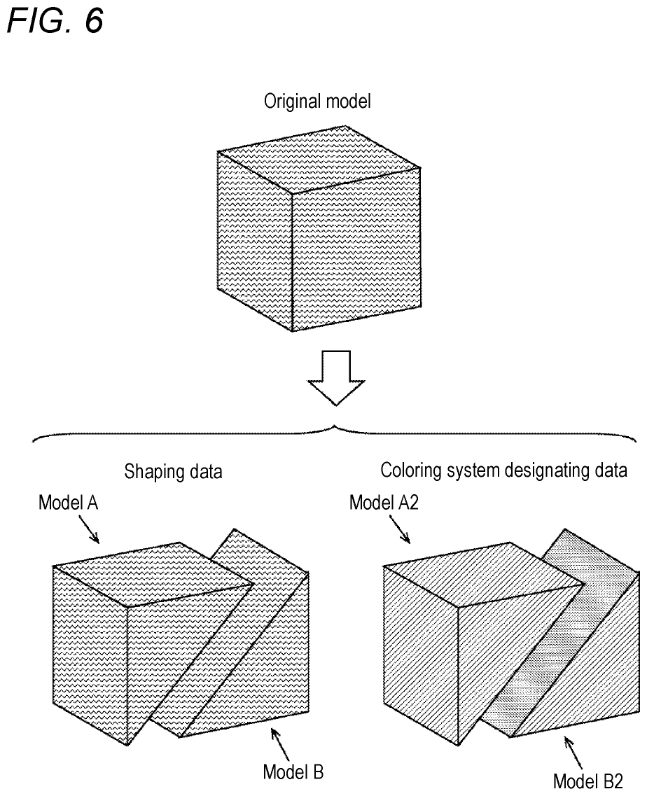

Next, the shaping data and the coloring system designating data used in the present example will be described in more detail. FIG. 6 is a view describing the shaping data and the coloring system designating data in more detail. As described above, in the present example, data indicating a plurality of shaped objects 50 respectively corresponding to the respective parts forming the object 40 is generated by dividing the data indicating the object 40. Furthermore, in this case, the shaping data and the coloring system designating data are generated as the data indicating the respective shaped objects 50.

Furthermore, FIG. 6 illustrates an example of an operation in a case where a cube-shaped object 40 is created similar to a case described using FIG. 2. In this case, as the data indicating the object 40, data indicating a cube illustrated as the original model in the drawing is used. As the plurality of shaped objects 50 used as parts, two triangular prism-shaped shaped objects 50 obtained by dividing the object 40 into two are shaped.

Furthermore, in this case, as the shaping data corresponding to each shaped object 50, data indicating the shape and color of the shaped object 50 as illustrated as model A and model B in the drawing is used. Moreover, in the present example, as the shaping data, data in which the surface region 502 and the end region 504 are not distinguished is used. If the surface region 502 and the end region 504 are not distinguished, for example, it means that whether to use the surface color system or the bulk color system for the way of coloring each position is not designated. As such shaping data, it is conceivable to use data in the same format as the data indicating the object 40. In this case, in the shaping data, it can be considered that the end region 504 is designated with a color in the same format as the surface region 502. More specifically, as the shaping data, for example, three-dimensional data in a known format can be suitably used.

Furthermore, in the present example, the way of coloring the surface region 502 and the end region 504 respectively is designated by further using the coloring system designating data. In this case, designating the way of coloring means designating which method, the surface color system or the bulk color system, to use for coloring. With this configuration, for example, the way of coloring for each of the surface region 502 and the end region 504 can be appropriately designated based on the coloring system designating data. Thus, for example, the way of coloring the surface region 502 and the way of coloring the end region 504 can be appropriately made different.

Furthermore, in the present example, the data in the same format as the shaping data is used as the coloring system designating data. Moreover, in this case, in the coloring system designating data, way of coloring is designated by differing the way of using colors from the shaping data. More specifically, in the present example, in the shaping data, color information is used to indicate the color to be colored for each position of the surface region 502 and the end region 504. On the other hand, in the coloring system designating data, color information is used to indicate the way of coloring used at each position. In this case, in the coloring system designating data, for example, the first color and the second color which are different from each other are used, the coloring by the surface color system and the first color are associated with each other, and the coloring by the bulk color system and the second color are associated with each other, so that the way of coloring used at each position can be designated.

More specifically, in this case, it is conceivable to use as the coloring system designating data, for example, data that indicates the shape of the shaped object 50 and in which the first color is set to the position where the coloring by the surface color system is to be performed and the second color is set to the position where the coloring by the bulk color system is to be performed. Furthermore, in this case, it is conceivable to use the coloring system designating data corresponding to the shaping data of model A and model B as illustrated as model A2 and model B2 in the drawing. In this case, as illustrated in the drawing, in each of the model A2 and the model B2, the designated color is made different between the position corresponding to the surface region 502 and the position corresponding to the end region 504. With this configuration, for example, one shaped object 50 can be colored through different methods depending on the position. Thus, for example, the way of coloring for the surface region 502 and the end region 504 can be appropriately made different.

Furthermore, in this case, by using the coloring system designating data in the same format as the shaping data, the coloring system designating data can be appropriately handled in the same manner as the shaping data by the software that handles the shaping data without using special software or the like. The software that handles the shaping data is, for example, software for creating or changing the shaping data. More specifically, with respect to the coloring system designating data, it is conceivable to designate the way of coloring (e.g., designate position to perform bulk color coloring) by, for example, the user designating on the software. Then, in this case, the way of coloring can be appropriately designated using the same software as that for designating the color for the shaping data. According to the present example, for example, in the coloring system designating data, the way of coloring can be appropriately designated by designating the color.

Further, the color indicated by the coloring system designating data can, for example, be considered not as the color of the shaped object 50 itself but as the color indicating the way of coloring. Moreover, regarding the color indicated by the coloring system designating data, for example, it can be considered that the way of coloring with respect to a position where the color is designated is indicated. Furthermore, the color indicated by the coloring system designating data can be considered as, for example, a color that is associated in advance with the way of coloring. In addition, in the coloring system designating data, it is conceivable to use a plurality of colors, each of which is associated with a different way of coloring. With this configuration, for example, various ways of coloring can be appropriately designated in the coloring system designating data.

Furthermore, when the coloring system designating data is considered in a more generalized manner, for example, it is data in the same format as the shaping data, and can be considered as data indicating the shape of the shaped object 50 and the color associated with at least a part of the shaped object 50, and the like. Furthermore, at least a part of the colors used in the coloring designating data can be considered to be, for example, a color associated with the way of coloring performed on the shaped object 50.

Furthermore, in the coloring system designating data of the present example, to indicate the shape of the shaped object 50 means to indicate the overall shape of the shaped object 50 indicated by the shaping data. With this configuration, for example, the way of coloring can be appropriately designated for each part of the shaped object 50. Furthermore, in this case, the coloring system designating data can be easily and appropriately created by reading the shaping data into software that handles the shaping data and changing the color in accordance with the way of coloring to be designated. Moreover, as the coloring system designating data, for example, it is conceivable to use data indicating only a part of the shape of the shaped object 50. Therefore, the coloring system designating data can be considered as, for example, data indicating the shape and color of at least a part of the shaped object 50 in the same format as the shaping data.

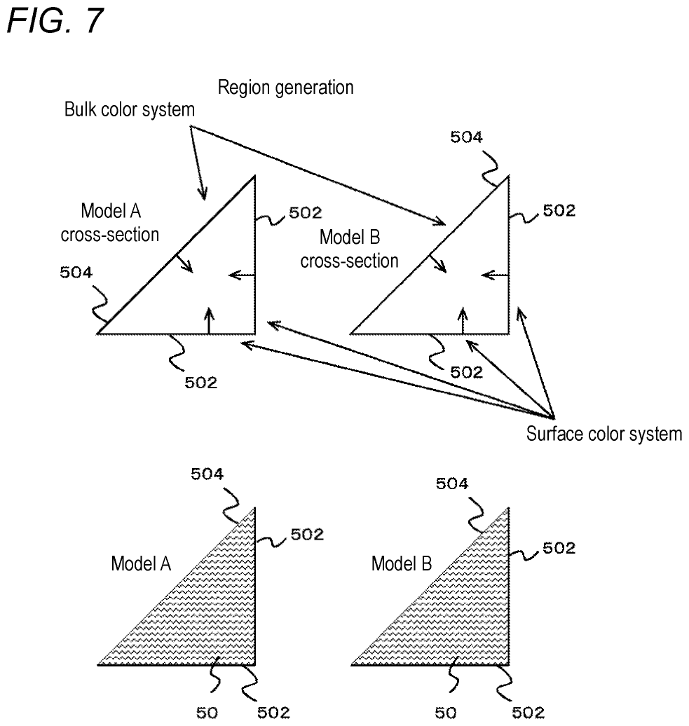

As described above, in the present example, the process of generating each region of the shaped object 50 is performed based on the shaping data and the coloring system designating data. FIG. 7 is a view describing the process of generating each region of the shaped object 50 in more detail.

As described above, in the present example, the way of coloring is made different depending on the position of the shaped object based on the coloring system designating data. More specifically, for example, in a case of a shaped object corresponding to the model A and the model B in FIG. 6, the way of coloring is designated such that the end region 504 is colored through the bulk color system and the surface region 502 is colored through the surface color system, as illustrated in the upper part of FIG. 7. In this case, regions corresponding to the surface region 502 and the end region 504 are generated with a configuration corresponding to the designation in the way of coloring, and slicing process is performed to generate slice data. Furthermore, the shaping device 12 (see FIG. 1) performs the shaping operation based on the generated slice data to shape the shaped object 50 corresponding to the model A and the model B, as illustrated at the lower part of FIG. 7. With such a configuration, for example, the shaped object 50 in which the way of coloring is made different between the surface region 502 and the end region 504 can be appropriately shaped.

As described above, in the present example, the surface color system (surface coloring system) is used as a way of coloring the surface region 502. Then, in this case, the surface region 502 can be considered as, for example, an example of a transmissive color portion. The transmissive color portion is, for example, a region that is colored using a material for coloring so that light entering from the outside can be transmitted. Furthermore, in this case, the transmissive color portion is formed, for example, in at least a part of the periphery of the light reflecting region such as the inner region 506 (see FIG. 3) in the present example. Moreover, the transmissive color portion can be considered to be, for example, a part colored by the surface color system.

In the present example, a bulk color system (bulk coloring system) is used as a way of coloring the end region 504. Then, in this case, the end region 504 can be considered as, for example, an example of a reflective color portion. The reflective color portion is, for example, a region formed using a light reflective material and a material for coloring to be colored so as to reflect light entering from the outside. Furthermore, the reflective color portion can be considered to be, for example, a part colored by the bulk color system.

Furthermore, in this case, focusing on the operation of the control unit 110 (see FIG. 1) in the shaping device 12, the operation of the control unit 110 can be considered, for example, to cause a plurality of inkjet heads in the head unit 102 (see FIG. 1) to form the transmissive color portion and the reflective color portion as at least a part of the region to be colored in the shaped object 50 based on the coloring system designating data. Furthermore, in this case, the coloring system designating data used in the present example can be considered as, for example, data that designates a position for performing the coloring through the bulk color system and a position for performing the coloring through the surface color system. Moreover, the coloring system designating data can be considered as, for example, data indicating the position to form the reflective color portion and the transmissive color portion. Furthermore, such data can be considered as, for example, data indicating a position to form at least one of the reflective color portion and the transmissive color portion. According to this example, for example, a way of coloring for a part of the shaped object 50 can be appropriately made different from other parts. This also allows, for example, the variously colored shaped object 50 to be appropriately shaped.

Regarding the way of coloring the shaped object 50 of the present example, it can be considered that the end region 504 which is a part of the shaped object 50 is colored through a method different from that of the surface region 502 which is other part. Then, in this case, the shaped object 50 can be considered to be, for example, a shaped object including other-system color portion which is a part colored through a predetermined method different from other parts. Moreover, in this case, the coloring system designating data can be considered as, for example, data indicating the position to form the other-system color portion. More specifically, in the present example, for example, the end region 504 can be considered as an example of other-system color portion. In addition, for example, when the way of coloring the end region 504 is considered as a standard way of coloring, the surface region 502 can be considered as an example of other-system color portion.

In addition, in the modified example of the configuration of the shaped object 50, it is conceivable that coloring may be performed in many systems as a way of coloring. In this case, for example, it is conceivable to form a shaped object including a plurality of other-system color portions that are colored by different methods. Furthermore, in this case, as the coloring system designating data, for example, it is conceivable to use data indicating the positions to form the respective other-system color portions. More specifically, in this case, it is conceivable that different colors are associated with different ways of coloring and the respective ways of coloring are designated by the difference in color in the coloring system designating data. With such a configuration, for example, a variously colored shaped object can be more appropriately shaped.

Furthermore, in the above description, as to the way of coloring the shaped object 50, an example where the way of coloring the surface region 502 and the way of coloring the end region 504 are made different has been described. However, in a modified example in the way of coloring the shaped object 50, the way of coloring a part of the shaped object 50 may be made different from the way of coloring the other part through another method. Various modified examples in the way of coloring the shaped object 50 will be described below. Other than the points described below, the way of shaping the shaped object 50 in each modified example is the same as or similar to the way of shaping described above with reference to FIGS. 1 to 7.

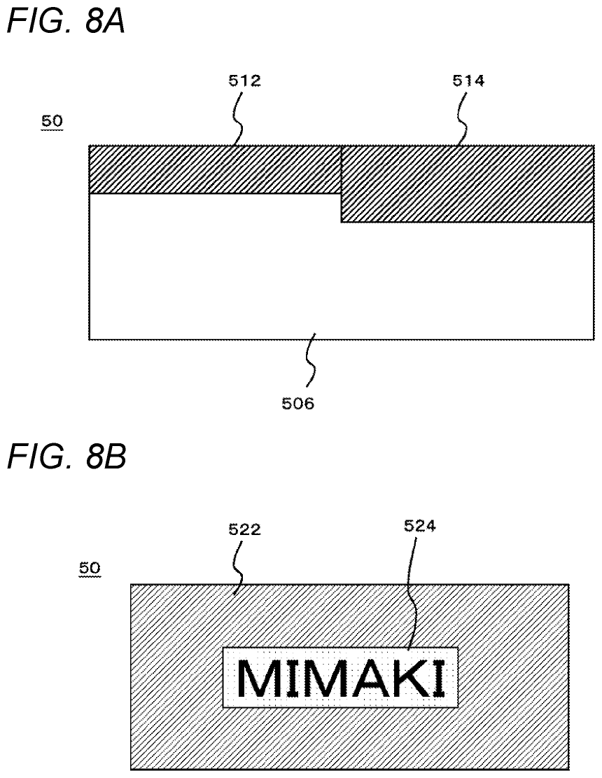

FIG. 8 is a diagram describing a modified example of a way of coloring the shaped object 50. In FIG. 8, the components denoted with the same reference numerals as those in FIGS. 1 to 7 may have the same or similar characteristics as those of the components in FIGS. 1 to 7.

FIG. 8A is a diagram illustrating an example of a region to be colored formed in a modified example of a way of coloring the shaped object 50 together with an inner region 506, and illustrates an example of a cross-sectional configuration of a part of the shaped object 50. In this modified example, at least a part of the shaped object 50 is colored by the surface color system. Then, in this case, the shaping device 12 (see FIG. 1) shapes the shaped object 50 including the light reflective inner region 506 formed using the white ink and the region to be colored. In this case, the region to be colored is formed on at least a part of the periphery of the inner region 506. Furthermore, in the present modified example, the shaping device 12 forms the region to be colored having the color portion 512 and the color portion 514 that are colored by different ways of coloring. The color portions 512 and 514 are made to have different thicknesses so that the way of coloring is made different.

Furthermore, more specifically, in the present modified example, the control unit 110 of the shaping device 12 (see FIG. 1) causes the plurality of inkjet heads in the head unit 102 (see FIG. 1) to form the color portion 512 formed so that the thickness in the normal direction has a first thickness and the color portion 514 formed so that the thickness in the normal direction has a second thickness different from the first thickness as at least a part of the region to be colored based on the coloring system designating data.

In this modified example, the color portion 512 is an example of a first thickness color portion. The color portion 514 is an example of a second thickness color portion. Furthermore, forming the color portion 512 to have the first thickness, and forming the color portion 514 to have the second thickness, for example, may be forming such that the designed thickness becomes the first thickness and the second thickness. Furthermore, when the designed thickness becomes a predetermined thickness, for example, it can be considered as becoming a thickness within a predetermined range including a predetermined thickness in consideration of the difference in the orientation of each position of the surface of the shaped object 50 or the change in the thickness caused by the influence of the shaping operation. Moreover, forming the color portion 512 to have the first thickness, and forming the color portion 514 to have the second thickness, for example, may be considered as forming the color portion 512 and the color portion 514 such that the difference between the first thickness and the second thickness is within a certain allowable range.

The normal direction can be considered as, for example, the normal direction at each position on the surface of the shaped object 50, and the like. The configuration of the shaped object 50 in this modified example can be considered to be, for example, a configuration in which the thickness of the region to be colored is changed depending on the position. Furthermore, in this modified example, as the coloring system designating data, for example, it is conceivable to use data indicating a position to form at least one of the color portion 512 and the color portion 514.

In the present modified example as well, for example, the way of coloring at part of the shaped object 50 can be appropriately made different from the other parts. Furthermore, in this case, various colors can be represented in the region to be colored, for example, by making the thickness of the color portion 512 different from the thickness of the color portion 514. More specifically, for example, the range of colors that can be represented in the region to be colored usually changes depending on the thickness of the region to be colored. Furthermore, in this case, it is considered preferable to reduce the thickness of the region to be colored when representing a bright color and increase the thickness of the region to be colored when representing a dark color. On the other hand, according to this modified example, for example, the thickness of a part to represent a bright color in the region to be colored can be reduced and the thickness of a part to represent a dark color can be increased. Therefore, according to this modified example, for example, the range of colors that can be represented in the region to be colored can be made wider.

Furthermore, as described above, in the present modified example, the region to be colored including the color portion 512 and the color portion 514 is formed by designating the way of coloring by the coloring system designating data. In this case, in the coloring system designating data, it is conceivable to set a predetermined first color to a position corresponding to the color portion 512, and set a predetermined second color different from the first color to a position corresponding to the color portion 514.

Furthermore, as described in relation with the shaping operation described with reference to FIGS. 1 to 7, for example, color conversion may be performed according to a profile in the operation of generating slice data. Then, in this case, when the thickness is changed depending on the position of the region to be colored as in this modified example, it is conceivable to use a profile prepared in advance according to each thickness. In this case, for example, as the profile, it is conceivable to use, for example, a first profile corresponding to the thickness of the color portion 512 and a second profile corresponding to the thickness of the color portion 514. Furthermore, it is conceivable to use a profile different from the first profile as the second profile.

Furthermore, when the profile to be used is changed according to the thickness in such a manner, the coloring system designating data can be considered as, for example, data that designates the profile to be used for each position of the shaped object 50. Moreover, in this case, focusing on the operation of the control unit 110, the control unit 110 causes a plurality of inkjet heads in the head unit 102 to form the color portion 512 subjected to color conversion process using the first profile and the color portion 514 subjected to a color conversion process using the second profile, as at least a part of the region to be colored based on the coloring system designating data. In this case, the color portion 512 is an example of a first profile corresponding part. The color portion 514 is an example of a second profile corresponding part.

Furthermore, the coloring system designating data for designating the profile to be used for each position of the shaped object 50 may be considered to be used other than when the thickness is changed depending on the position of the region to be colored. More specifically, such coloring system designating data can also be suitably used, for example, when the way of color management is changed depending on the position of the region to be colored.

FIG. 8B is a diagram illustrating an example of a region to be colored formed in a further modified example of a way of coloring the shaped object 50, and illustrates an example of a way of coloring a part of the surface of the shaped object 50. In the present modified example, the shaping device 12 forms a region to be colored having a color portion 522 and a color portion 524 which are colored through different ways of coloring. Furthermore, in this case, the color portion 522 and the color portion 524 are colored through different ways of coloring by differing the profiles to use in the color conversion process.

Furthermore, more specifically, in the present modified example, the color portion 522 is a region where color conversion process is performed using a standard profile. In this case, the standard profile is, for example, a default profile used in the shaping device 12. The standard profile can be considered as, for example, a profile set in consideration of the entire range of colors that can be represented by the shaping device 12. The color portion 524 is a region where color conversion process is performed using a profile for representing a specific color more faithfully. In this case, the profile for more faithfully representing a specific color can be considered to be, for example, a profile used when more faithfully representing a predetermined color illustrated in a color sample or the like.

Furthermore, regarding the color portion 524, more specifically, it may be desired to faithfully represent a color used in a corporate color, a trademark, or the like with high accuracy depending on the use of the shaped object 50 and the like. In this case, for some colors, it is desired to faithfully represent a specific color (e.g., a color of a specific number in the color sample) of a predetermined color sample (e.g., DIC color sample, pantone color sample, etc.). However, the standard profile used in the shaping device 12 is usually set so as to represent various colors with high accuracy, rather than specific colors. In this case, for important colors such as corporate colors, there may be a difference between the color actually represented and the desired color.

On the other hand, in the present modified example, a profile other than the standard profile is used with a position where representation of a predetermined color is particularly important such as a corporate color as the color portion 524. Furthermore, in this case, a profile set so that a desired specific color can be represented more faithfully is used. With this configuration, for example, a specific color can be represented more accurately and more faithfully. Moreover, the shaping of the shaped object 50 thus can be appropriately performed with higher accuracy.

In addition, in the present modified example, the color portion 522 is an example of a first profile corresponding part. The color portion 524 is an example of a second profile corresponding part. Moreover, as the coloring system designating data, for example, it is conceivable to use data indicating a position to form at least one of the color portion 522 and the color portion 524.

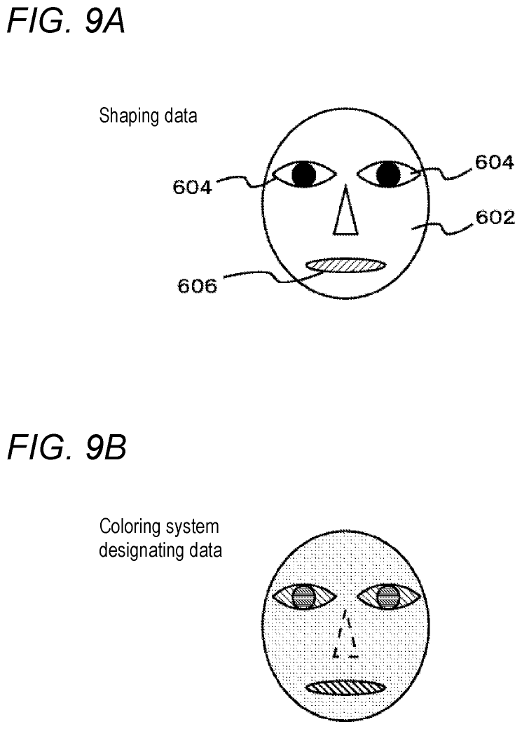

Furthermore, in a further modified example in the way of coloring the shaped object 50, it can be considered to make the texture different depending on the position of the shaped object 50 by differing the way of coloring according to the position of the shaped object 50. FIG. 9 is a diagram describing a further modified example in the way of coloring the shaped object 50. FIGS. 9A and 9B illustrate an example of the shaping data and the coloring system designating data used in this modified example.

In the shaping device 12, it is also considered to shape a shaped object 50 indicating a natural object such as a living thing. In this case, for example, it is conceivable to perform shaping of the shaped object 50 based on the shaping data indicating a target object imaged by a scanner (3D scanner) or the like. However, depending on the target object indicated by the shaped object 50, the reality may be insufficient if coloring is merely performed, and it may be difficult to perform shaping with high quality.

More specifically, for example, in a case where the shaped object 50 representing a human being is shaped in the shaping device 12, it is desirable to represent the eyes, the skin, and the like with a highly realistic texture. However, in this case, if the same way of coloring is adopted for the entire shaped object 50, it becomes difficult to represent each part of the shaped object 50 with high texture.

On the other hand, in the present modified example, a higher texture can be represented in each part of the shaped object 50 by differing the way of coloring for each part of the shaped object 50. More specifically, when shaping the shaped object 50 representing a human being, for example, it is conceivable to color the eyes and the skin through a way of coloring adapted to each. In this case, coloring the eyes and the skin through a way of coloring adapted to each means, for example, coloring the eye parts with a way of coloring that can more appropriately represent the texture of the eyes and coloring the skin part with a way of coloring that can more appropriately represent the texture of the skin. Furthermore, in this case, it is preferable that the other parts are also colored by a way of coloring adapted to the relevant part. For example, it is conceivable to color the lip part and the like through a way of coloring that can more appropriately represent the texture of the lip and the like. Such a way of coloring can be considered as, for example, a method of preparing in advance a coloring method unique to each part (eyes, skin, lips, etc.) as a way of coloring for the part (default way of coloring for the part), and designating an optimal way of coloring for each position (each part) of the shaped object, and the like.

Furthermore, in this case, as the shaping data, for example, as illustrated in FIG. 9A, it is conceivable to use data indicating the shape of the shaped object 50 and the color of each position of the shaped object 50. Furthermore, as the coloring system designating data, for example, as illustrated in FIG. 9B, it is conceivable to use data indicating the shape of the shaped object 50, and indicating a color associated with the way of coloring each part such as the eyes, skin, lips, and the like. With this configuration, for example, each part of the shaped object 50 can be appropriately colored through a way of coloring suitable for that part. Furthermore, for example, a more highly realistic texture can be represented in each part of the shaped object 50.

Furthermore, in this case, for example, as illustrated in the drawing, it is considered that the way of coloring is different for the black eye part and the white eye part in the eye part. With such a configuration, the eye part can be colored with higher quality. Furthermore, in the modified example, the parts corresponding to the eyes, the skin, and the lips can be considered as an example of the other-system color portion.

Furthermore, depending on the use of the shaped object 50, it may be desirable to color at least a part of the shaped object 50 with a highly transparent texture. More specifically, in a case where a shaped object 50 representing a human being is shaped, it may be desirable to color parts such as the eyes and the skin, in particular, with a highly transparent texture. Then, in such a case, it is conceivable that at least a part of the shaped object 50 is colored through a system of overlapping a large number of layered parts.

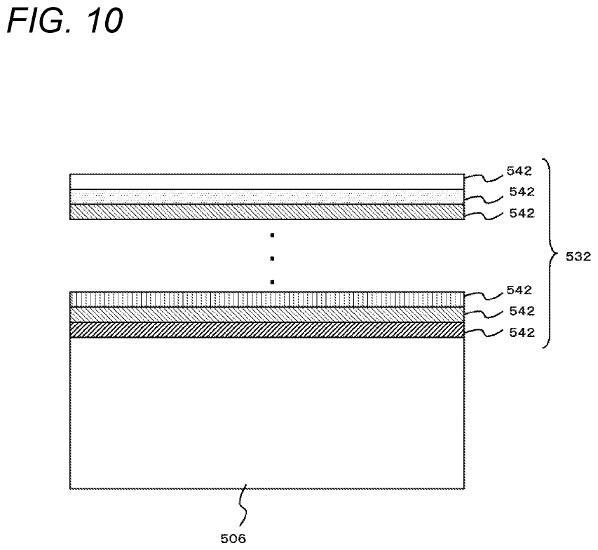

FIG. 10 is a diagram describing a further modified example of a way of coloring the shaped object 50, and illustrates an example of a cross-sectional configuration of a color portion 532 that forms a part of the region to be colored in the shaped object 50 together with the inner region 506. In the present modified example, the color portion 532 is a part that is colored by overlapping a plurality of layer parts 542. In this case, each layer part 542 is a layered part whose thickness direction is in the normal direction to the surface of the shaped object 50. Furthermore, in the present modified example, each layer part 542 does not mean a layer of ink that is layered in the layering direction by the layered shaping method, but means a part having a predetermined thickness in the normal direction. In this case, the overlapping of the plurality of layer parts 542 can be considered as, for example, that the shaped object 50 at the time when the shaping is completed is shaped such that the plurality of layer parts 542 overlap each other. Furthermore, at the part of the shaped object 50 in which the normal direction is parallel to the layering direction, the respective ink layers layered in the layering direction in the layered shaping method may be used as they are as the layer part 542. In this case, it is preferable that the thickness of the layer part 542 in the other parts of the shaped object 50 be the same as that of the ink layer layered in the layering direction in the layered shaping method.

Furthermore, in the present modified example, each of the layer parts 542 is colored in a light color so that the transmittance of light with respect to the color portion 532 becomes sufficiently high. When the transmittance of light with respect to the color portion 532 is sufficiently high, for example, the light is transmitted to the color portion 532, so that the color can be represented in the color portion 532 with the inner region 506 as the background. With this configuration, for example, the color portion 532 can be colored with a highly transparent texture. It is considered that the number of layer parts 542 is, for example, about 10 or more (e.g., about 10 to 30).

Furthermore, in this case, various colors can be represented in the color portion 532 by making the colors of the respective layer parts 542 different from each other. Moreover, coloring with the impression that the inside is transparent becomes possible by making the color of the layer part 542 at a position close to the surface of the shaped object 50 different from the color of the layer part 542 at a position distant from the surface. Such a way of coloring can be considered as, for example, a method of performing coloring by overlapping a plurality of layer parts 542 having different colors. In this case, overlapping the plurality of layer parts 542 having different colors can be considered as, for example, selecting colors for each layer part 542 independently of each other. Moreover, overlapping the plurality of layer parts 542 having different colors can be considered as, for example, overlapping a plurality of layer parts 542 having different colors as necessary. Therefore, depending on the color to be represented in the color portion 532, at least some of the plurality of layer parts 542 may have the same color. In addition, in the present modified example, the color portion 532 is an example of a layer system color representing part in which the color is represented by overlapping layered parts having different colors.

When using the color portion 532 in which the plurality of layer parts 542 overlap, for example, it is conceivable to form such a color portion 532 only as a part of the region to be colored in the shaped object 50, and perform coloring through another method for the other part of the region to be colored. In this case, as the coloring system designating data, for example, it is conceivable to use data that designates a part to be subjected to coloring such as the color portion 532. Such coloring system designating data can also be considered as, for example, data indicating a position to form the color portion 532. The data indicating the position to form the color portion 532 is, for example, data in which the color of the position corresponding to the color portion 532 is set to a predetermined color in the parts corresponding to the region to be colored of the shaped object 50. Furthermore, as the data indicating the position to form the color portion 532, for example, data in which the color of the position not corresponding to the color portion 532 is set to a predetermined color may be used. Furthermore, in this case, the control unit 110 of the shaping device 12 (see FIG. 1), for example, causes the plurality of inkjet heads in the head unit 102 to form the color portion 532 as at least a part of the region to be colored based on the coloring system designating data. Even with such a configuration, for example, a way of coloring a part of the shaped object 50 can be appropriately made different from other parts.

In a further modified example in the way of coloring the shaped object 50, for example, it can be considered to use the color portion 532 in which a plurality of layer parts 542 overlap and differing the way of forming the color portion 532 according to the part of the shaped object 50. In this case, it can be considered that the way of coloring is different with respect to the difference in the way of overlapping the plurality of layer parts 542 at each part. Furthermore, the region to be colored in the shaped object 50 can also be considered to have, for example, a plurality of color portions 532 that differ in the way of coloring. More specifically, as described above, the color portion 532 in which the plurality of layer parts 542 overlap can be colored with a highly transparent texture. Therefore, for example, at the time of shaping the shaped object 50 representing a human being, and the like, shaping can be performed with a highly realistic texture by using such a color portion 532 for the colors of eyes, skin, lip, and the like.

However, eyes, skin, lip, and the like usually have different colors and textures. Therefore, when the color portion 532 in which the plurality of layer parts 542 overlap is used for these parts, it is more preferable to represent the colors with a configuration that matches each color and texture. For example, in this case, it is conceivable to make the range of colors selected as the respective colors of the plurality of layer parts 542, the number of layer parts 542 to overlap, and the like different depending on the part of the shaped object 50. Making the range of colors selected as the respective colors of the plurality of layer parts 542 different depending on the part means, for example, selecting the color of the layer part 542 forming the color portion 532 of the part corresponding to each of eyes, skin, lip, and the like from a group of colors suitable for each representation of the eyes, skin, lip, and the like. With this configuration, a more highly realistic texture can be represented at each part of the shaped object 50.

### INDUSTRIAL APPLICABILITY

The present disclosure can be suitably used in, for example, a shaping device.

What is claimed is:

1. A shaping device for shaping a three-dimensional shaped object, the shaping device comprising:
a plurality of ejection heads each ejecting a material of the shaped object; and
a control unit that controls the operation of the plurality of ejection heads, wherein
at least some of the plurality of ejection heads ejects the material for coloring, and
the control unit causes the plurality of ejection heads to eject the material so that the shaped object in which a way of coloring for at least one part is different from a way of coloring for at least other parts is shaped based on shaping data, which is data indicating shape and color of the shaped object, and coloring system designating data, which is data indicating the way of coloring for at least one part of the shaped object.

2. The shaping device according to claim 1, wherein
the coloring system designating data is data indicating the shape and color of at least a part of the shaped object in the same format as the shaping data, and
at least some of the colors used in the coloring system designating data is associated with the way of coloring performed with respect to the shaped object.

3. The shaping device according to claim 2, wherein the coloring system designating data indicates an overall shape of the shaped object indicated by the shaping data.

4. The shaping device according to claim 1, wherein the control unit makes the way of coloring different between the one part of the shaped object and the other at least parts so that the way of shaping a region where the same color is designated in the shaping data is different.

5. The shaping device according to claim 2, wherein the control unit makes the way of coloring different between the one part of the shaped object and the other at least parts so that the way of shaping a region where the same color is designated in the shaping data is different.

6. The shaping device according to claim 3, wherein the control unit makes the way of coloring different between the one part of the shaped object and the other at least parts so that the way of shaping a region where the same color is designated in the shaping data is different.

7. The shaping device according to claim 1, wherein
the plurality of ejection heads includes,
a plurality of coloring heads, each of which is a plurality of ejection heads for ejecting the material for coloring, and
a light reflective material head, which is an ejection head for ejecting the light reflective material,
the shaped object including, a light reflecting region, which is a light reflecting region formed using the light reflective material, and a region to be colored, which is a colored region formed by using the material for coloring, is shaped as the shaped object,
the control unit, based on the coloring system designating data, causes the plurality of coloring heads and the light reflective material head to form, as at least a part of the region to be colored,
a reflective color portion, which is a region that is colored to reflect light entering from the outside by being formed using the light reflective material and the material for coloring, and
a transmissive color portion, which is a region that is colored to transmit light entering from the outside by using the material for coloring and is formed in at least a part of a periphery of the light reflecting region, and
the coloring system designating data is data indicating a position to form at least one of the reflective color portion and the transmissive color portion.

8. The shaping device according to claim 2, wherein
the plurality of ejection heads includes,
a plurality of coloring heads, each of which is a plurality of ejection heads for ejecting the material for coloring, and
a light reflective material head, which is an ejection head for ejecting the light reflective material,
the shaped object including, a light reflecting region, which is a light reflecting region formed using the light reflective material, and a region to be colored, which is a colored region formed by using the material for coloring, is shaped as the shaped object,
the control unit, based on the coloring system designating data, causes the plurality of coloring heads and the light reflective material head to form, as at least a part of the region to be colored,
a reflective color portion, which is a region that is colored to reflect light entering from the outside by being formed using the light reflective material and the material for coloring, and
a transmissive color portion, which is a region that is colored to transmit light entering from the outside by using the material for coloring and is formed in at least a part of a periphery of the light reflecting region, and
the coloring system designating data is data indicating a position to form at least one of the reflective color portion and the transmissive color portion.

9. The shaping device according to claim 3, wherein
the plurality of ejection heads includes,
a plurality of coloring heads, each of which is a plurality of ejection heads for ejecting the material for coloring, and
a light reflective material head, which is an ejection head for ejecting the light reflective material,
the shaped object including, a light reflecting region, which is a light reflecting region formed using the light reflective material, and a region to be colored, which is a colored region formed by using the material for coloring, is shaped as the shaped object,
the control unit, based on the coloring system designating data, causes the plurality of coloring heads and the light reflective material head to form, as at least a part of the region to be colored,
a reflective color portion, which is a region that is colored to reflect light entering from the outside by being formed using the light reflective material and the material for coloring, and
a transmissive color portion, which is a region that is colored to transmit light entering from the outside by using the material for coloring and is formed in at least a part of a periphery of the light reflecting region, and
the coloring system designating data is data indicating a position to form at least one of the reflective color portion and the transmissive color portion.

10. The shaping device according to claim 4 wherein
the plurality of ejection heads includes,
a plurality of coloring heads, each of which is a plurality of ejection heads for ejecting the material for coloring, and
a light reflective material head, which is an ejection head for ejecting the light reflective material,
the shaped object including, a light reflecting region, which is a light reflecting region formed using the light reflective material, and a region to be colored, which is a colored region formed by using the material for coloring, is shaped as the shaped object,
the control unit, based on the coloring system designating data, causes the plurality of coloring heads and the light reflective material head to form, as at least a part of the region to be colored,
a reflective color portion, which is a region that is colored to reflect light entering from the outside by being formed using the light reflective material and the material for coloring, and
a transmissive color portion, which is a region that is colored to transmit light entering from the outside by using the material for coloring and is formed in at least a part of a periphery of the light reflecting region, and
the coloring system designating data is data indicating a position to form at least one of the reflective color portion and the transmissive color portion.

11. The shaping device according to claim 1, wherein
the plurality of ejection heads includes,
a plurality of coloring heads, each of which is a plurality of ejection heads for ejecting the material for coloring, and
a light reflective material head, which is an ejection head for ejecting the light reflective material,
the shaped object including, a light reflecting region, which is a light reflecting region formed using the light reflective material, and a region to be colored, which is a colored region formed by using the material for coloring in at least a part of a periphery of the light reflecting region, is shaped as the shaped object,
the control unit, based on the coloring system designating data, causes the plurality of coloring heads and the light reflective material head to form, as at least a part of the region to be colored,
a first thickness color portion formed so that a thickness in a normal direction becomes a first thickness, and
a second thickness color portion formed so that a thickness in the normal direction becomes a second thickness different from the first thickness, and
the coloring system designating data is data indicating a position to form at least one of the first thickness color portion and the second thickness color portion.

12. The shaping device according to claim 2, wherein
the plurality of ejection heads includes,
a plurality of coloring heads, each of which is a plurality of ejection heads for ejecting the material for coloring, and
a light reflective material head, which is an ejection head for ejecting the light reflective material,
the shaped object including, a light reflecting region, which is a light reflecting region formed using the light reflective material, and a region to be colored, which is a colored region formed by using the material for coloring in at least a part of a periphery of the light reflecting region, is shaped as the shaped object,
the control unit, based on the coloring system designating data, causes the plurality of coloring heads and the light reflective material head to form, as at least a part of the region to be colored,
a first thickness color portion formed so that a thickness in a normal direction becomes a first thickness, and
a second thickness color portion formed so that a thickness in the normal direction becomes a second thickness different from the first thickness, and
the coloring system designating data is data indicating a position to form at least one of the first thickness color portion and the second thickness color portion.

13. The shaping device according to claim 3, wherein
the plurality of ejection heads includes,
a plurality of coloring heads, each of which is a plurality of ejection heads for ejecting the material for coloring, and
a light reflective material head, which is an ejection head for ejecting the light reflective material,
the shaped object including, a light reflecting region, which is a light reflecting region formed using the light reflective material, and a region to be colored, which is a colored region formed by using the material for coloring in at least a part of a periphery of the light reflecting region, is shaped as the shaped object,
the control unit, based on the coloring system designating data, causes the plurality of coloring heads and the light reflective material head to form, as at least a part of the region to be colored,
a first thickness color portion formed so that a thickness in a normal direction becomes a first thickness, and
a second thickness color portion formed so that a thickness in the normal direction becomes a second thickness different from the first thickness, and
the coloring system designating data is data indicating a position to form at least one of the first thickness color portion and the second thickness color portion.

14. The shaping device according to claim 4, wherein
the plurality of ejection heads includes,
a plurality of coloring heads, each of which is a plurality of ejection heads for ejecting the material for coloring, and
a light reflective material head, which is an ejection head for ejecting the light reflective material,
the shaped object including, a light reflecting region, which is a light reflecting region formed using the light reflective material, and a region to be colored, which is a colored region formed by using the material for coloring in at least a part of a periphery of the light reflecting region, is shaped as the shaped object,
the control unit, based on the coloring system designating data, causes the plurality of coloring heads and the light reflective material head to form, as at least a part of the region to be colored,
a first thickness color portion formed so that a thickness in a normal direction becomes a first thickness, and
a second thickness color portion formed so that a thickness in the normal direction becomes a second thickness different from the first thickness, and
the coloring system designating data is data indicating a position to form at least one of the first thickness color portion and the second thickness color portion.

15. The shaping device according to claim 1, wherein
the control unit, based on a result of a color conversion process performed according to a profile that associates a color space corresponding to a color used in the shaping data with a color space corresponding to a color of the material for coloring, causes the plurality of ejection heads to form the shaped object including a region to be colored, which is a colored region formed using the material for coloring,
the control unit, based on the coloring system designating data, causes the plurality of ejection heads to form, as at least a part of the region to be colored,
a first profile corresponding part in which the color conversion process is performed using a first profile, and
a second profile corresponding part in which the color conversion process is performed using a second profile different from the first profile, and
the coloring system designating data is data indicating a position to form at least one of the first profile corresponding part and the second profile corresponding part.

16. The shaping device according to claim 1, wherein
the control unit causes
the plurality of ejection heads to form the shaped object including a region to be colored, which is a colored region formed using the material for coloring, and
based on the coloring system designating data, causes the plurality of ejection heads to form as at least a part of the region to be colored, a layer system color representing part, which is a region where a plurality of layered parts having a normal direction in the surface of the shaped object as a thickness direction is overlapped, in which color is represented by overlapping the layered parts having different colors, and
the coloring system designating data is data indicating a position to form the layer system color representing part.

17. The shaping device according to claim 1, wherein
the shaped object including other-system color portion, which is a part colored through a predetermined method different from other parts, is shaped, and
the coloring system designating data is data indicating a position to form the other-system color portion.

18. The shaping device according to claim 9, wherein
the shaped object including a plurality of other-system color portions colored through different methods is shaped, and
the coloring system designating data is data indicating positions to form the respective other-system color portion.

19. The shaping device according to claim 9, wherein
the shaped object representing a human being is shaped, and
the other-system color portion is a part corresponding to the eyes or the skin of the human being.

20. A shaping method for shaping a three-dimensional shaped object, the shaping method comprising the steps of:
using a plurality of ejection heads each ejecting a material of the shaped object to eject a material for coloring from at least some of the plurality of ejection heads; and
causing the plurality of ejection heads to eject the material to shape the shaped object in which a way of coloring for at least one part is different from a way of coloring for at least other parts is shaped based on shaping data, which is data indicating shape and color of the shaped object, and coloring system designating data, which is data indicating the way of coloring for at least one part of the shaped object.
